(19) United States
(12) Patent Application Publication
(10) Pub. No.: US 2025/0385272 A1
(43) Pub. Date: Dec. 18, 2025

(54) FUEL CELLS AND ELECTROLYZER ELECTRODES CONTAINING NON-IONOMERIC BINDERS

(71) Applicant: GM Global Technology Operations LLC, Detroit, MI (US)

(72) Inventors: Nagappan Ramaswamy, Rochester Hills, MI (US); Venkata Raviteja Yarlagadda, South Lyon, MI (US); Roland J. Koestner, Plymouth, MI (US); Swaminatha P. Kumaraguru, Rochester Hills, MI (US)

(73) Assignee: GM Global Technology Operations LLC, Detroit, MI (US)

(21) Appl. No.: 18/740,847

(22) Filed: Jun. 12, 2024

(51) Int. Cl. H01M 4/86; B60L 50/72; H01M 4/92

(52) U.S. Cl. CPC H01M 4/8668; B60L 50/72; H01M 4/926; H01M 2250/20

(57) ABSTRACT

An electrode of an electrochemical device includes a carbon-based support structure, an ionically conductive material dispersed on and within the support structure, a catalyst dispersed on and within the support structure, and a non-ionomeric hydrocarbon-based binder dispersed on the support structure. The ionically conductive material enables the transport of protons across the electrode, the catalyst promotes a chemical reaction of a fuel received at the electrode, and the binder retains the electrode. The electrode may be included in an electrochemical device, such as a fuel cell.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to an electrode of an electrochemical device, such as a fuel cell configured to power a vehicle. Typically, electrodes of fuel cells include an ionomer, such as a perfluorosulfonic acid (PFSA) based ionomer, to act as a physical binder for a carbon supported or dispersed catalyst nanoparticle and maintain mechanical integrity of the electrode. Such ionomers also enable proton transport across the catalyst layer of the electrode.

However, PFSA ionomers act to poison or reduce the kinetic activity of the catalyst layers, such as platinum, over the life of the electrochemical device. In so doing, PFSA ionomers reduce the efficiency and block the active sites of the catalyst, thereby requiring a higher concentration of catalyst at the electrode. Moreover, PFSA ionomers are typically applied with high ratios of PFSA ionomer relative to the mass of carbon in the substrate, such as a ratio of about 1.0 or greater. Further, PFSA ionomers degrade slowly over time when disposed of and, thus, present an environmental hazard.

### SUMMARY

One aspect of the disclosure provides an electrode of an electrochemical device. The electrode includes a carbon-based support structure, an ionically conductive material dispersed on and within the support structure, a catalyst dispersed on and within the support structure, and a non-ionomeric hydrocarbon-based binder dispersed on the support structure. The ionically conductive material enables the transport of protons across the electrode. The catalyst promotes a chemical reaction of a fuel received at the electrode. The binder retains the electrode.

Implementations of the disclosure may include one or more of the following optional features. In some examples, the ionically conductive material includes a sulfate.

In some implementations, the catalyst includes at least one from the group consisting of (i) platinum, and (ii) platinum alloy.

In some further implementations, a ratio of platinum to a mass of carbon in the support structure is less than or equal to 0.6.

In some aspects, the binder includes at least one of the group consisting of (i) carboxymethyl cellulose, (ii) polyninylidene fluoride, and (iii) styrene butadiene rubber.

In some further aspects, a ratio of carboxymethyl cellulose in the binder to the mass of carbon in the support structure is less than or equal to 0.2.

In some even further aspects, a ratio of polyvinylidene fluoride in the binder to the mass of carbon in the support structure is less than or equal to 0.2.

In some configurations, the catalyst and the binder, combined with a solvent, are dispersed on the support structure as a catalyst dispersion ink.

In some further configurations, the solvent is devoid of alcohol.

In some examples, a thickness of catalyst dispersed on the support structure is less than or equal to 20 microns.

Another aspect of the disclosure provides an electrochemical device. The electrochemical device includes an electrode. The electrode includes a carbon-based support structure, an ionically conductive material including sulfate and dispersed on and within the support structure, a catalyst including platinum and dispersed on and within the support structure, and a non-ionomeric hydrocarbon-based binder dispersed on the support structure. The ionically conductive material enables the transport of protons across the electrode. The catalyst promotes a chemical reaction of a fuel received at the electrode, the catalyst including a ratio of platinum to a mass of carbon in the support structure that is less than or equal to 0.6. The binder retains the electrode, the binder including at least one of the group consisting of (i) carboxymethyl cellulose, (ii) polyninylidene fluoride, and (iii) styrene butadiene rubber.

Implementations of this aspect of the disclosure may include one or more of the following optional features. In some examples, a ratio of carboxymethyl cellulose in the binder to the mass of carbon in the support structure is less than or equal to 0.2.

In some implementations, a ratio of polyvinylidene fluoride in the binder to the mass of carbon in the support structure is less than or equal to 0.2.

In some aspects, the catalyst and the binder, combined with a solvent, are dispersed on the support structure as a catalyst dispersion ink.

In some further aspects, the solvent is devoid of alcohol.

In some configurations, a thickness of catalyst dispersed on the support structure is less than or equal to 20 microns.

Yet another aspect of the disclosure provides a vehicle. The vehicle includes a fuel cell, and the fuel cell includes an electrode. The electrode includes a carbon-based support structure, an ionically conductive material including sulfate and dispersed on and within the support structure, a catalyst including platinum and dispersed on and within the support structure, and a non-ionomeric hydrocarbon-based binder dispersed on the support structure. The ionically conductive material enables the transport of protons across the electrode. The catalyst promotes a chemical reaction of a fuel received at the electrode, the catalyst including a ratio of platinum to a mass of carbon in the support structure that is less than or equal to 0.6. The binder retains the electrode, the binder including at least one of the group consisting of (i) carboxymethyl cellulose, (ii) polyninylidene fluoride, and (iii) styrene butadiene rubber.

Implementations of this aspect of the disclosure may include one or more of the following optional features. In some examples, a ratio of carboxymethyl cellulose in the binder to the mass of carbon in the support structure is less than or equal to 0.2.

In some implementations, a ratio of polyninylidene fluoride in the binder to the mass of carbon in the support structure is less than or equal to 0.2.

In some aspects, the catalyst and the binder, combined with a solvent, are dispersed on a substrate as a catalyst dispersion ink with a thickness of catalyst dispersed on the substrate being greater than or equal to 10 microns.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle including an electrochemical device.

FIG. 2 is a representation of an ionomer-free electrode of the electrochemical device.

FIG. 3 is a diagram showing the flow of fuel, oxygen or air, electrons, and protons during operation of the electrochemical device.

FIG. 4 is a line graph comparing hydrogen-air polarization curves during operation of an electrochemical device having an electrode with a PFSA based ionomer and the electrochemical device having the ionomer-free electrode.

FIG. 5 is a bar graph comparing electrochemical surface areas (ECSA) before and after operational life cycles for the electrochemical device having the electrodes with the PFSA based ionomer and the electrochemical device having the ionomer-free electrode.

FIG. 6 is a line graph comparing electrode proton transport resistance as a function of relative humidity for the electrochemical devices having the electrode with the PFSA based ionomer and the electrochemical devices having the ionomer-free electrode.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Electrodes used in fuel cells are responsible for conducting electrons and catalyzing the conversion of chemical energy into electrical energy. The electrical energy is ultimately used to provide power to a machine, such as a vehicle, in which the fuel cell is disposed. The electrodes do not include a perfluorosulfonic acid (PFSA) based ionomer but, rather, the electrodes use a carbon support structure with sulfate functionality for transport of protons across the electrode, the transport of which enables the conversion of chemical energy into electrical energy. Furthermore, non-ionomeric binders are used to provide both structural integrity to the electrode and to bind catalysts to the electrode. The catalyst may include platinum and is responsible for supporting the reaction between hydrogen and oxygen in the fuel cell, which also enables the conversion of chemical energy into electrical energy. The binder may include carboxymethyl cellulose (CMC), polyvinylidene fluoride, and/or a combination of both CMC and polyvinylidene.

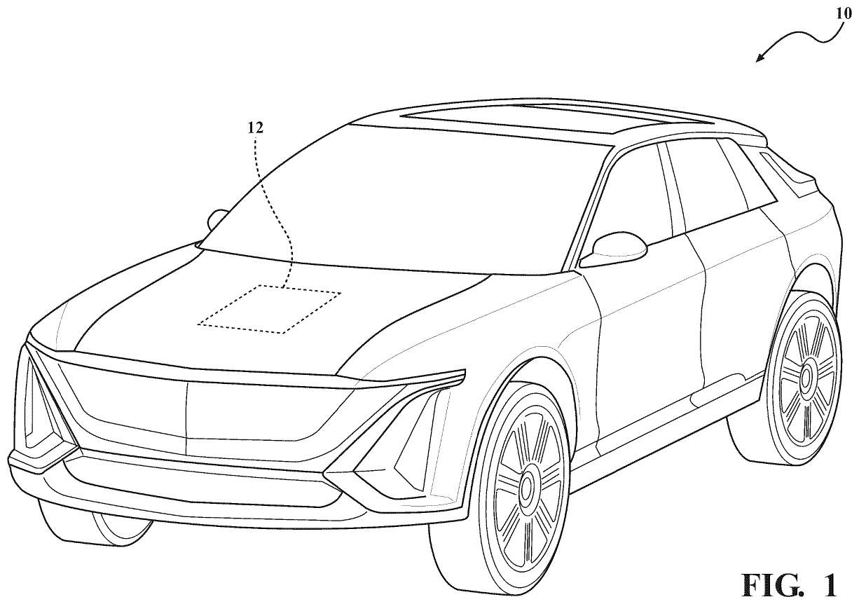

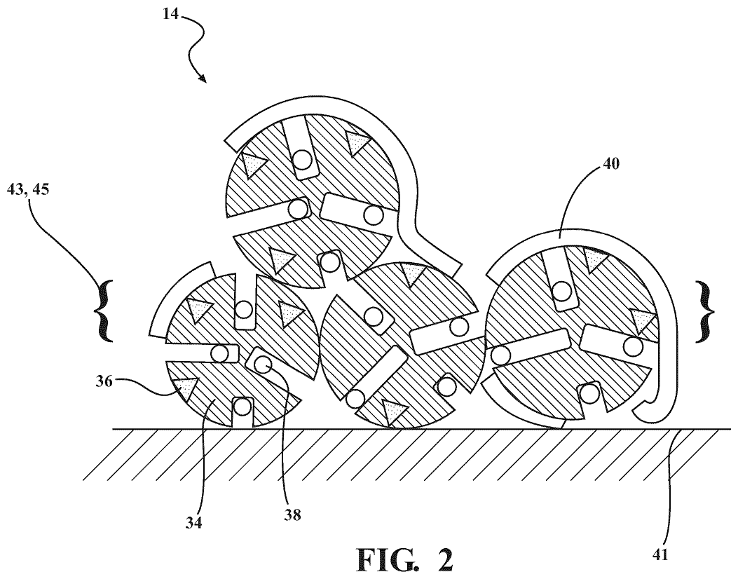

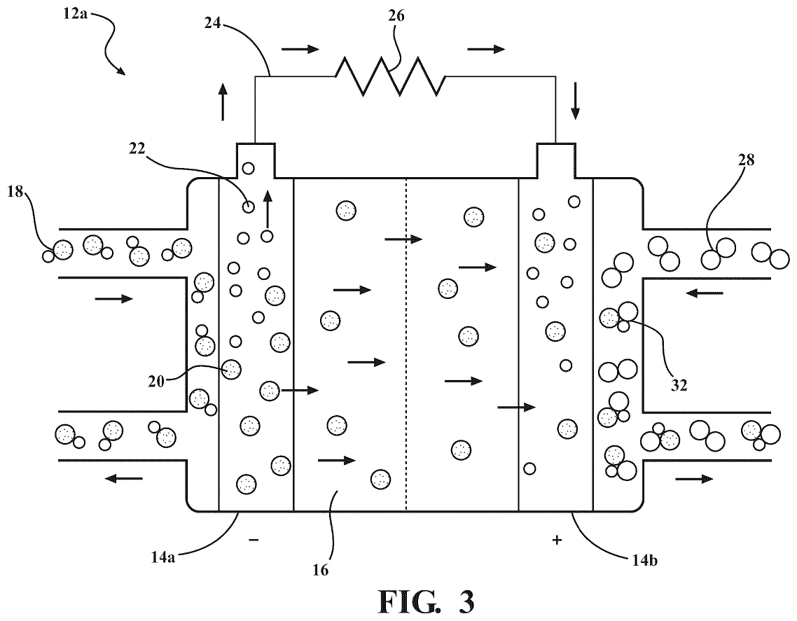

With reference to FIGS. 1-3, a vehicle 10 includes an electrochemical device 12, such as a fuel cell system having a plurality of fuel cells 12a arranged in a fuel cell stack that generates power for driving a propulsion system of the vehicle 10. To provide power from the electrochemical device 12 to the vehicle 10, a conversion of chemical energy into electrical energy occurs within each fuel cell 12a, the resulting electrical energy powering the vehicle 10 and enabling its operation. Each fuel cell 12a includes a pair of electrodes 14, such as an anode 14a and a cathode 14b. The anode 14a is negatively charged and the cathode 14b is positively charged. The anode 14a and the cathode 14b are separated by an electrolyte 16 of the fuel cell 12a.

During operation of the electrochemical device 12, hydrogen 18 is fed to the anode 14a of the fuel cell 12a and the anode 14a enables separation of the hydrogen 18 into protons 20 and electrons 22. Any excess hydrogen 18 that is not separated into protons 20 and electrons 22 is exhausted out of the fuel cell 12a or recirculated into the fuel cell 12. The protons 20 flow through the electrolyte 16 while the electrons 22 flow through an external circuit 24 where an electric charge 26 is generated. It is the electric charge 26 that provides power to the vehicle 10. As the electrons 22 travel through the external circuit 24 and the protons 20 travel through the electrolyte 16, both the electrons 22 and the protons 20 eventually enter the cathode 14b. Air or oxygen 28 is fed to the cathode 14b of the fuel cell 12a and the cathode 14b facilitates the electrons 22 and the protons 20 combining with the oxygen 28 to create water 32. The water 32 exhausts from the fuel cell 12a as waste, or may be recirculated back into the fuel cell 12a. Additionally, any excess oxygen 28 that is not combined with the electrons 22 and the protons 20 is exhausted from the fuel cell 12a or recirculated back into the fuel cell 12a. The composition of the electrode 14 provides structural integrity and allows specific actions to occur at both the anode 14a and the cathode 14b, such as separating and combining protons 20, oxygen 28, and electrons 22, as well as facilitating the flow of protons 20 across the electrode 14.

The electrode 14 includes a carbon-based support structure 34 that serves as a vessel or a body of the electrode 14. To enable transport of protons 20 across the electrode 14, an ionically conductive material 36 is dispersed on and/or at least partially within the support structure 34 of the electrode 14. For example, the ionically conductive material 36 may include a sulfate. Furthermore, the electrode 14 includes a catalyst 38 dispersed on and/or at least partially within the support structure 34. In the illustrated example, the catalyst 38 includes platinum, as platinum may be an effective element that sufficiently promotes the splitting of hydrogen 18 into protons 20 and electrons 22 on the anode 14a or recombination of oxygen 28 with protons 20 and electrons 22 to form water 32 on the cathode 14b. Moreover, the electrode includes a binder 40 that assists in physically retaining the carbon-based support structure 34, the ionically conductive material 36, and the catalyst 38 together and/or at a substrate 41 of the electrode 14. As discussed further below, the binder 40 is a non-ionomeric and hydrocarbon-based binder that has a reduced or negligible or nonexistent effect on the kinetic activity of the catalyst 38 and has a reduced or negligible or nonexistent environmental effect as compared to PFSA ionomer based binders.

In some applications, the binder 40 includes carboxymethyl cellulose (CMC), while in other applications, the binder 40 that is used includes polyvinylidene (PVDF) or styrene butadiene rubber (SBR). In some other applications, the binder 40 that is used includes a combination of CMC and/or PVDF and/or SBR at an adjustable ratio. Thus, the binder 40 maintains the physical integrity and operational efficiency of the electrode 14.

Because the ionomer-free binder 40 of the electrode 14 has a negligible or non-existent effect on the kinetic activity of the platinum-based catalyst 38 over the lifecycle of the electrode 14, a mass ratio of platinum to carbon in the support structure 34 may be reduced without affecting the operational efficiency of the fuel cell 12a. For example, the ratio of platinum to mass of carbon in the support structure 34 may be less than or equal to 0.6. This ratio allows for the catalyst 38 to be effective in promoting the splitting of the hydrogen 18 into protons 20 and electrons 22 or recombination of oxygen 28 to water 32. Furthermore, the catalyst 38 may have a reduced thickness when dispersed on the support structure 34, such as a thickness of between about five (5) microns and twenty (20) microns. Because the electrode 14 includes the ionomer-free binder 40, the platinum catalyst 38 will experience reduced or negligible or non-existent degradation over the life of the electrochemical device 12. Accordingly, a reduced amount of conductive material 36 may be used in the forming of the electrode 14 while still allowing the electrode 14 to maintain its operational effectiveness.

Formation of the electrode 14 includes dispersing a known amount of the catalyst 38 into the binder 40 in a solvent 43, thus creating a catalyst dispersion ink 45. Moreover, the binder 40 may include CMC and/or PVDF. The catalyst dispersion ink 45 may then be applied to the substrate 41 so the catalyst 38 and binder 40 can be dispersed across the support structure 34. As described below, the catalyst dispersion ink 45 may be milled in the presence of ZrO₂ beads prior to coating the support structure 34 and/or substrate 41 with the catalyst dispersion ink 45.

A ratio of CMC as the binder 40 to the mass of carbon in the support structure 34 may be less than or equal to about 0.2. Additionally, the dispersion of the catalyst dispersion ink 45 and the concentration of catalyst 38 in the catalyst dispersion ink 45 is configured to achieve a thickness of catalyst 38 that is greater than or equal to about five (5) microns on the support structure 34, such as a thickness between about five (5) microns and twenty (20) microns. In some cases, the solvent 43 may include alcohol, such as propanol. In these cases, alcohol may increase the ability of the binder 40 to be evenly dispersed on the support structure 34. A mass ratio of alcohol to water in the solvent 43 may be between about 1.0 and 3.0. In some examples, the solvent 43 may be devoid of alcohol.

Prior to applying the catalyst dispersion ink 45 to the substrate 41, the catalyst dispersion ink 45 is milled in the presence of milling media, such as zirconia (ZrO₂) beads, to achieve a sufficient particle size throughout the catalyst dispersion ink 45. For example, the catalyst dispersion ink 45 may be milled overnight, or for a period of eight (8) hours or more, ten (10) hours or more, twelve (12) hours or more, and the like. After milling the catalyst dispersion ink 45, it may be applied to the substrate 41 to form the electrode 14.

In some examples, formation of the electrode 14 includes dispersing a known amount of the catalyst 38 into the binder 40 in the solvent 43, where the binder 40 includes a combination of CMC and PVDF or another suitable non-soluble latex material. The catalyst dispersion ink 45 may then be applied to the substrate 41 so the catalyst 38 and binder 40 can be dispersed across the substrate 41.

A ratio of CMC as the binder 40 to the mass of carbon in the support structure 34 may be less than or equal to about 0.2, and a ratio of PVDF in the binder 40 to the mass of carbon in the support structure 34 may be less than or equal to about 0.2. Additionally, the dispersion of the catalyst dispersion ink 45 and the concentration of catalyst 38 in the solvent 43 is configured to achieve a thickness of catalyst 38 that is greater than or equal to about five (5) microns on the support structure 34, such as a thickness between about five (5) microns and about twenty (20) microns. In some cases, the solvent 43 may include alcohol, or the solvent 43 may be devoid of alcohol. Furthermore, the PVDF of the binder 40 helps to promote adhesion of the binder onto the support structure 34 as PVDF is a latex that is fairly soft and not soluble in water, allowing it to easily conform to the geometry of the support structure 34 and provide additional adhesion strength.

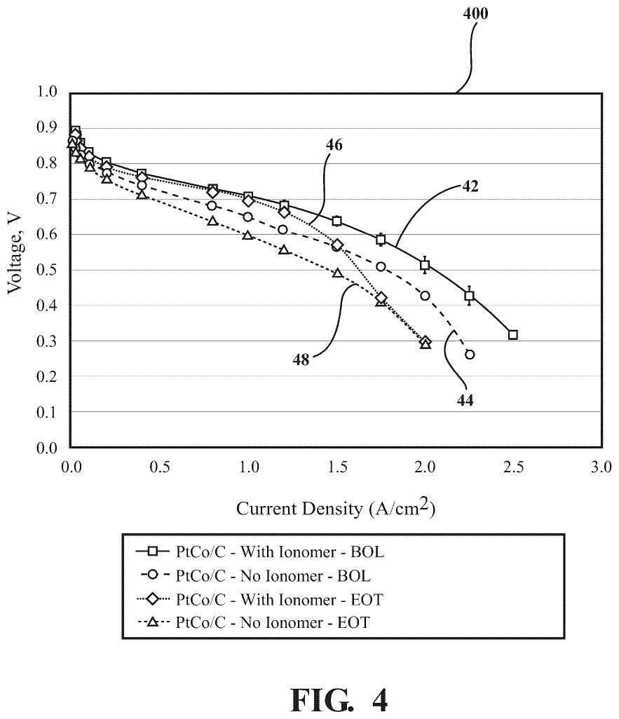

With reference to FIG. 4, a line chart 400 compares hydrogen-air polarization curves during operation of electrochemical devices having an electrode with a PFSA based ionomer and the electrochemical device 12 having the ionomer-free electrode 14, where a first line 42 represents operation of the electrochemical device with the PFSA based ionomer at the beginning of its lifecycle and a third line 46 represents operation of the PFSA having electrochemical device toward the end of its lifecycle. A second line 44 represents operation of the ionomer-free electrochemical device at the beginning of its lifecycle and a fourth line 48 represents operation of the ionomer-free electrochemical device toward the end of its lifecycle. As shown, the chart 400 maps voltage produced by the electrochemical devices at different current densities.

As shown, while the second line 44 represents voltage capabilities of the ionomer-free electrochemical device 12 being slightly less than the PFSA having electrochemical device represented by the first line 42, the voltage capabilities provided by the electrochemical device 12 represented by the second line 44 is still viable for sufficient fuel cell operation.

Further, comparison of the third line 46 and the fourth line 48 shows that, when the respective electrochemical devices are toward the end of their lifecycles, the ionomer-free electrochemical device 12 may degrade to a less severe degree as compared to the PFSA having electrochemical device, especially at higher current densities.

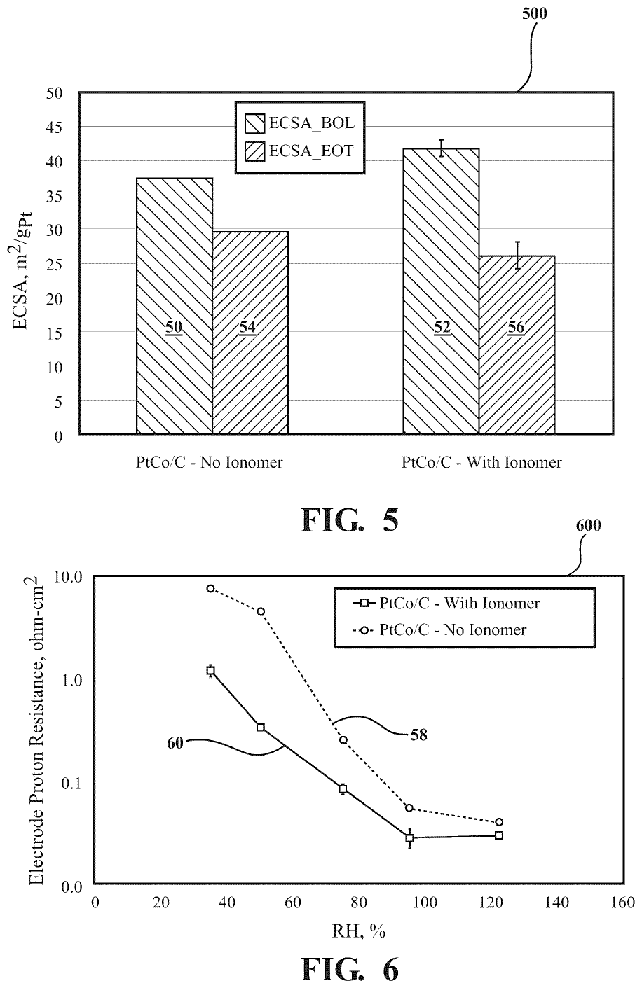

With reference to FIG. 5, a bar graph 500 compares electrochemical surface areas (ECSA) before and after operational life cycles for the electrochemical device having the electrodes with the PFSA based ionomer and the electrochemical device 12 having the ionomer-free electrode 14. ECSA is defined by the effective surface area of the catalyst 38 on the support structure 34, the catalyst 38 in the form of fine platinum nanoparticles. The greater the effective surface area of the nanoparticles, the more efficient the catalyst 38 may split the hydrogen 18 into protons 20 and electrons 22, or recombine oxygen 28 to water 32, meaning the electrochemical device 12 can operate more efficiently. Over time, as the electrochemical device 12 is used, platinum may inherently degrade, becoming less and less effective. Ionomers increase the degradation rate of platinum. A first bar 50 represents the total effective surface area of the platinum catalyst 38 nanoparticles at the beginning of life of the electrochemical device 12 with the electrode 14 without ionomers. A second bar 52 represents the total effective surface area of the platinum catalyst nanoparticles at the beginning of life of the fuel cell with an electrode that includes ionomers. A third bar 54 represents the total effective surface area of the platinum catalyst 38 nanoparticles toward the end of life of the electrochemical device 12 having the ionomer-free electrode 14. A fourth bar 56 represents the total effective surface area of the platinum catalyst nanoparticles toward the end of life of the fuel cell with the electrode that includes ionomers. It is shown that the reduction in effective surface areas of the platinum catalyst 38 from the first bar 50 to the third bar 54 is less dramatic than the reduction in effective surface areas of the platinum catalyst from the second bar 52 to the fourth bar 56. Thus, the electrode 14 that is ionomer-free may not degrade the catalyst 38 as quickly or significantly as compared to the electrode that includes ionomers.

With reference to FIG. 6, a line chart 600 includes two electrode-proton transport curves comparing electrode proton transport resistance as a function of relative humidity for the electrochemical device having the electrode with the PFSA based ionomer and the electrochemical device 12 having the ionomer-free electrode 14. Determining the resistance to proton transport involves measuring the resistance of the electrode 14 as a function of relative humidity in the cathode 14b. In general, the greater the relative humidity, the lower the resistance of the electrode 14. A first line 58 represents the resistance of the ionomer-free electrode 14, while a second line 60 represents the resistance of the PFSA having electrode. Both the first line 58 and the second line 60 show that resistance is decreased as the relative humidity in the cathode 14b is increased. As shown, the resistance levels during operation of the electrochemical device 12 having the ionomer-free electrode 14 are substantially similar or slightly higher relative to the resistance levels during operation of the PFSA based ionomer having electrochemical device.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. An electrode of an electrochemical device, the electrode comprising:
a carbon-based support structure;
an ionically conductive material dispersed on and within the support structure, the ionically conductive material enabling the transport of protons across the electrode;
a catalyst dispersed on and within the support structure, the catalyst promoting a chemical reaction of a fuel received at the electrode; and
a non-ionomeric hydrocarbon-based binder dispersed on the support structure, the binder retaining the electrode.

2. The electrode of claim 1, wherein the ionically conductive material comprises a sulfate.

3. The electrode of claim 1, wherein the catalyst comprises at least one from the group consisting of (i) platinum, and (ii) platinum alloy.

4. The electrode of claim 3, wherein a ratio of platinum to a mass of carbon in the support structure is less than or equal to 0.6.

5. The electrode of claim 1, wherein the binder comprises at least one of the group consisting of (i) carboxymethyl cellulose, (ii) polyninylidene fluoride, and (iii) styrene butadiene rubber.

6. The electrode of claim 5, wherein a ratio of carboxymethyl cellulose in the binder to the mass of carbon in the support structure is less than or equal to 0.2.

7. The electrode of claim 5, wherein a ratio of polyvinylidene fluoride in the binder to the mass of carbon in the support structure is less than or equal to 0.2.

8. The electrode of claim 1, wherein the catalyst and the binder, combined with a solvent, are dispersed on the support structure as a catalyst dispersion ink.

9. The electrode of claim 8, wherein the solvent is devoid of alcohol.

10. The electrode of claim 1, wherein a thickness of catalyst dispersed on the support structure is less than or equal to 20 microns.

11. An electrochemical device comprising:
an electrode comprising:
a carbon-based support structure;
an ionically conductive material comprising sulfate and dispersed on and within the support structure, the ionically conductive material enabling the transport of protons across the electrode;
a catalyst comprising platinum and dispersed on and within the support structure, the catalyst promoting a chemical reaction of a fuel received at the electrode, and the catalyst including a ratio of platinum to a mass of carbon in the support structure that is less than or equal to 0.6; and
a non-ionomeric hydrocarbon-based binder dispersed on the support structure, the binder retaining the electrode, and the binder comprising at least one of the group consisting of (i) carboxymethyl cellulose, (ii) polyninylidene fluoride, and (iii) styrene butadiene rubber.

12. The electrochemical device of claim 11, wherein a ratio of carboxymethyl cellulose in the binder to the mass of carbon in the support structure is less than or equal to 0.2.

13. The electrochemical device of claim 11, wherein a ratio of polyvinylidene fluoride in the binder to the mass of carbon in the support structure is less than or equal to 0.2.

14. The electrochemical device of claim 11, wherein the catalyst and the binder, combined with a solvent, are dispersed on the support structure as a catalyst dispersion ink.

15. The electrochemical device of claim 14, wherein the solvent is devoid of alcohol.

16. The electrochemical device of claim 11, wherein a thickness of catalyst dispersed on the support structure is less than or equal to 20 microns.

17. A vehicle comprising:
a fuel cell comprising:
an electrode comprising:
a carbon-based support structure;
an ionically conductive material comprising sulfate and dispersed on and within the support structure, the ionically conductive material enabling the transport of protons across the electrode;
a catalyst comprising platinum and dispersed on and within the support structure, the catalyst promoting a chemical reaction of a fuel received at the electrode, and the catalyst including a ratio of platinum to a mass of carbon in the support structure that is less than or equal to 0.6; and
a non-ionomeric hydrocarbon-based binder dispersed on the support structure, the binder retaining the electrode, and the binder comprising at least one of the group consisting of (i) carboxymethyl cellulose, (ii) polyninylidene fluoride, and (iii) styrene butadiene rubber.

18. The vehicle of claim 17, wherein a ratio of carboxymethyl cellulose in the binder to the mass of carbon in the support structure is less than or equal to 0.2.

19. The vehicle of claim 17, wherein a ratio of polyninylidene fluoride in the binder to the mass of carbon in the support structure is less than or equal to 0.2.

20. The vehicle of claim 17, wherein the catalyst and the binder, combined with a solvent, are dispersed on a substrate as a catalyst dispersion ink with a thickness of catalyst dispersed on the substrate being less than or equal to 20 microns.
